(19) United States
(12) Patent Application Publication
(10) Pub. No.: US 2010/0287529 A1
(43) Pub. Date: Nov. 11, 2010

(54) Systems and Methods for Generating Multimedia Applications

(75) Inventors: Manuel Ricardo Fonseca Costa, Lisboa (PT); Mario Filipe Pataco Anico Franco, Arraiolos (PT); Hugo Manuel Pereira Ataide Silveira, Alverca (PT); Jose Miguel Rodrigues Remedio, Barcelona (ES); Ivan de Almeida Soares Franco, Almada (PT); Nuno Alexandre Almeida de Sousa Capeta, Lazarim (PT)

Correspondence Address: King & Spalding LLP, 401 Congress Avenue, Suite 3200, Austin, TX, 78701, US

(73) Assignee: YDreams - Informatica, S.A. Joint Stock Company

(21) Appl. No.: 12/436,376

(22) Filed: May 6, 2009

(51) Int. Cl. G06F 9/44

(52) U.S. Cl. 717/105

(57) ABSTRACT

A computer implemented method for developing a multimedia application is provided. A multimedia asset over a data network from a user. A library of a plurality of internal software modules is maintained. A user interface is provided to allow a user to select one or more of the plurality of internal software modules, and configure a plurality of parameters for controlling a selected internal software module, wherein at least one of the configured parameters references the multimedia asset received over the data network from the user. A first multimedia application is automatically generated including the user-selected internal software module, an identifier for determining the version of the user-selected internal software module, and the plurality of user-configured parameters including the reference to the multimedia asset received over the data network from the user. An updated user-selected internal software module is received. A second multimedia application is automatically generated including the updated user-selected internal software module; an identifier for determining the version of the updated user-selected internal software module, and the plurality of user-configured parameters including the reference to the multimedia asset received over the data network from the user.

### TECHNICAL FIELD

The present disclosure relates generally to online development and generation of multimedia applications incorporating user supplied media content.

### BACKGROUND

At present, multimedia applications are typically created by software developers as custom projects. These projects must be updated by developers and provide, at most, limited opportunities for non-technical users to incorporate different media content. Software corrections and backward compatible enhancements cannot be automatically incorporated into the finished product and require developer involvement.

### SUMMARY

In accordance with the teachings of the present disclosure, disadvantages and problems associated with the use of existing software development and version control systems have been reduced.

In certain embodiments, a computer implemented method for developing a multimedia application is provided. A multimedia asset over a data network from a user. A library of a plurality of internal software modules is maintained. A user interface is provided to allow a user to select one or more of the plurality of internal software modules, and configure a plurality of parameters for controlling a selected internal software module, wherein at least one of the configured parameters references the multimedia asset received over the data network from the user. A first multimedia application is automatically generated including the user-selected internal software module, an identifier for determining the version of the user-selected internal software module, and the plurality of user-configured parameters including the reference to the multimedia asset received over the data network from the user. An updated user-selected internal software module is received. A second multimedia application is automatically generated including the updated user-selected internal software module; an identifier for determining the version of the updated user-selected internal software module, and the plurality of user-configured parameters including the reference to the multimedia asset received over the data network from the user.

In certain embodiments, software embodied in tangible computer-readable media is provided. The software is executable by a processor to receive a multimedia asset over a data network from a user; maintain a library of a plurality of internal software modules; provide a user interface configured to allow a user to: select one or more of the plurality of internal software modules, and configure a plurality of parameters for controlling a selected internal software module, wherein at least one of the configured parameters references the multimedia asset received over the data network from the user; automatically generate a first multimedia application, which includes: the user-selected internal software module, an identifier for determining the version of the user-selected internal software module, and the plurality of user-configured parameters including the reference to the multimedia asset received over the data network from the user; receive an updated user-selected internal software module; and automatically generate a second multimedia application, which includes: the updated user-selected internal software module, an identifier for determining the version of the updated user-selected internal software module, and the plurality of user-configured parameters including the reference to the multimedia asset received over the data network from the user.

In certain embodiments, a computing system includes a processor and a memory coupled to the processor. The processor is enabled to receive a multimedia asset over a data network from a user; maintain a library of a plurality of internal software modules; provide a user interface configured to allow a user to: select one or more of the plurality of internal software modules, and configure a plurality of parameters for controlling a selected internal software module, wherein at least one of the configured parameters references the multimedia asset received over the data network from the user; automatically generate a first multimedia application, which includes: the user-selected internal software module, an identifier for determining the version of the user-selected internal software module, and the plurality of user-configured parameters including the reference to the multimedia asset received over the data network from the user; receive an updated user-selected internal software module; and automatically generate a second multimedia application, which includes: the updated user-selected internal software module, an identifier for determining the version of the updated user-selected internal software module, and the plurality of user-configured parameters including the reference to the multimedia asset received over the data network from the user.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a graphical user interface that enables a user to create a multimedia application, according to an example embodiment of the present disclosure;

FIG. 2 illustrates a process and data flow for generating a multimedia application, according to an example embodiment of the present disclosure;

FIG. 3 illustrates an example workflow performed according to an example embodiment of the present disclosure;

FIG. 4 illustrates an example system for generating a multimedia application, according to an example embodiment of the present disclosure;

FIG. 5 illustrates an example workflow process triggered when an updated version of a software module is created, according to an example embodiment of the present disclosure; and

FIG. 6 illustrates an example method for generating a multimedia application, in accordance with certain embodiments of the present disclosure.

### DETAILED DESCRIPTION

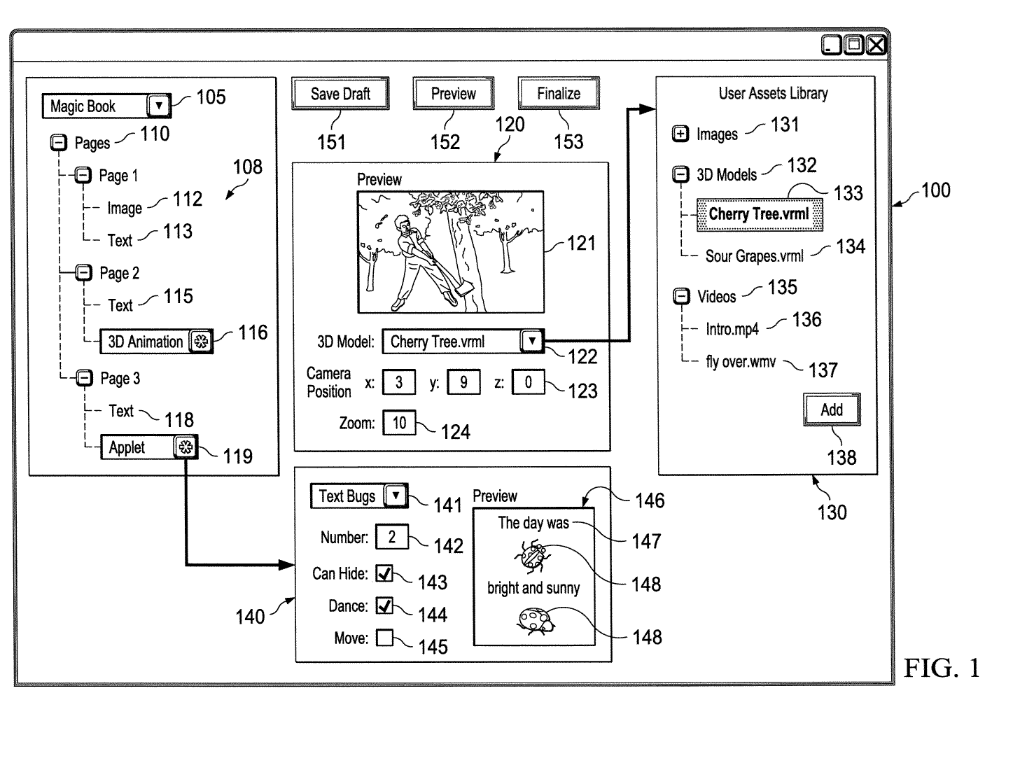

Preferred embodiments and their advantages over the prior art are best understood by reference to FIGS. 1-6 below. However, the present disclosure may be more easily understood in the context of a high level description of certain embodiments.

FIG. 1 illustrates graphical user interface 100 that enables a user to create a multimedia application, according to an example embodiment of the present disclosure. Graphical user interface (GUI) 100 may include an application type selector 105, a collection of application elements 108, one or more property pages 120 and 140, a library selection pane 130, and/or one or more action buttons 151, 152 and 153. GUI 100 may be a browser-based application or other application technology allowing a user to access from a remote location, e.g., from another office, company, city, or country.

GUI 100 provides the user, e.g., a non-technical user, with an intuitive approach for building and configuring a multimedia application from one or more core components including user-supplied content. In this non-limiting example, a user begins this process by selecting an application type (e.g., with application type selector 105) and configuring the selected application type by manipulating the collection of application elements 108. One or more application element 108 may be configurable using a property page (e.g., property pages 120 and 140). A property page may be a collection of elements such as, for example, text entry fields, drop down boxes, radio buttons, and preview panes, each of which allows the user to fine tune a parameter of the application. Further, any parameter or element requiring media content may trigger the library selection pane 130 to allow the user to select from, or add to, a library of one or more user-supplied media files, projects, etc. The one or more action buttons 151, 152, and 153 allow the user to indicate her progress to the system by, for example, saving a draft, requesting an online preview, or finalizing the application.

Application type selector 105 is a user interface component, e.g., a drop-down list, that allows the user to select from a predetermined library or set of application types. For example, the user may want to create a two dimensional (2D) or three dimensional (3D) “magic book” application, a 3D augmented or virtual reality application (AR/VR application), or a dynamic billboard advertisement. In some embodiments, these application types may be mutually exclusive. In some embodiments, a user may select more than one application type for a given application.

A “magic book” application may be a book that supplements text with interactive elements. In some embodiments, a magic book is a physical book on which one or more virtual elements are superimposed when the reader is wearing special display goggles. For example, a children's story book might tell the story of George Washington chopping down the cherry tree. The left-hand page may show the text of the story while the right-hand page may show an illustration. If the reader is wearing stereoscopic goggles, the reader will see a 3D animation that appears to come out of the right-hand page instead of seeing the printed illustration. In another example, the entire book, including the text and animation, may be shown on a computer display.

An AR/VR application may include a scene and scene elements with which a user may interact. For example, an AR/VR application may show, on a fixed screen or using goggles, a person walking around a room in a museum. The system may display, e.g., virtual animations such as virtual monkeys climbing up columns or a virtual tour guide standing next to the real person. In another example, an AR/VR application may superimpose the real person, imaged by one or more cameras, onto a purely virtual scene, e.g., under water or on the International Space Station.

A dynamic billboard application may include preprogrammed or interactive elements. For example, a large computer display-possibly mounted to a wall in an outdoor sports arena—may display a dynamic advertisement for a brand of bottled water. The display may show a repeating or randomized video of a gurgling brook along with a logo for the brand. When the display senses a pedestrian walking past, e.g., via a video camera or an infrared sensor, the display may show a bottle of spring water rising from the water along with a message pointing the pedestrian to a nearby concession stand.

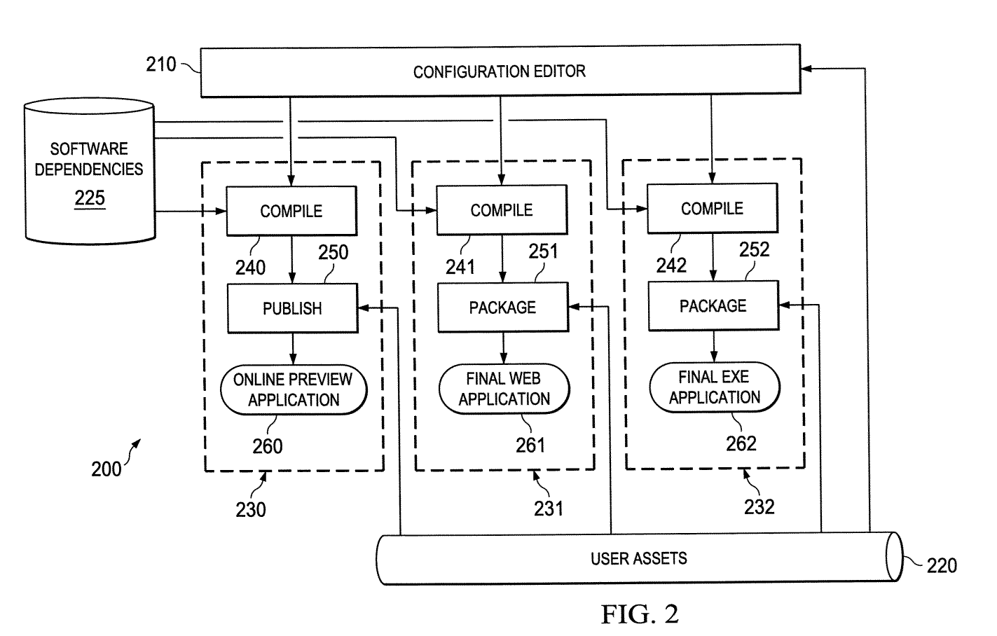

A collection of application elements 108 may be shown as a tree-style hierarchy of elements. For example, the illustrated collection of application elements 108 includes root node Pages 110; first-level children Page 1, Page 2, and Page 3; and second-level children Image 112, Text 113, Text 115, 3D Animation 116, Text 118, Applet 119. This tree-style hierarchy is a common visual representation of nested one-to-many data relationships. The first level children are labeled here as pages to correspond to the selected application type of Magic Book, but may have other labels instead or in addition. In this example, each first-level child-page-has corresponding text, e.g., Text 113, Text 115, and Text 118, as well as one additional element. A text element may be plain or formatted text and may include translations into various languages or dialects. GUI 100 may provide a text editor or may require a user to upload final text files into the library of user assets 220 (illustrated in FIG. 2).

In this example, a page is merely a collection of application elements, e.g., Text 113, and may have no properties of its own. Alternatively a page may have configurable properties such as, for example, a page number, a shape, and a visual texture. Page 1 includes Text 113 and Image 112, a static illustration or picture. Image 112 may have configurable properties, e.g., length and width, color adjustments, and/or transparency. Page 2 includes Text 115 and 3D animation 116. 3D animation 116 may be a reference to a dynamic component capable of displaying a 3D animation. The GUI element representing 3D animation 116 provides a configuration icon that, when activated by the user, may cause GUI 100 to show properties page 120. Page 3 includes Text 118 and Applet 119. Applet 119 may be a dynamic element supplied as part of the multimedia application development environment (e.g., in software dependencies 225, shown in FIG. 2) or may be a user-supplied element. Applet 119 may be displayed with a configuration icon that, when activated by the user, may cause the display of properties page 140.

A properties page, e.g., property page 120, may be a collection of GUI elements that allow the user to configure, or fine tune, the behavior, appearance, or content of an application element. A properties page may be a new window or may be drawn in a portion of an existing window. Each properties page is discussed as follows.

Properties page 120 allows a user to configure 3D Animation 116 by specifying what content is to be shown and how. For example, properties page 120 may include the following GUI elements: preview pane 121, 3D Model selector 122, Camera Position input 123, and Zoom input 124. Preview pane 121 may show a 2D or 3D Preview of 3D Model 122 and may be blank if no model is selected or if no preview is available for the selected model. The preview, if available, may be static or dynamic. 3D Model 122 displays the name of the currently selected model, e.g., a description of a virtual 3D scene and/or object(s) represented in the Virtual Reality Modeling Language (VRML). 3D Model 122 has an icon that, when activated by the user, may cause GUI 100 to show library selection pane 130, entitled User Assets Library, for selecting from one or more media assets supplied by a user of the system. Camera Position 123 may allow the user to specify the vantage point for viewing the 3D model, i.e., the position of a virtual camera in the virtual scene through which a user may view the virtual scene. Zoom 124 may allow the user to specify the zoom level of the virtual camera located at Camera Position 123. These particular properties are meant to illustrate possible properties for configuring the display of 3D Model 122. An alternative properties page may show Preview pane 121 along with pan, tilt, zoom, and/or rotate controls for the virtual camera and may update the view shown in Preview pane 121 in response to activation of those controls.

User assets library 130 may also be a new window or may be drawn in a portion of an existing window. User assets library 130 allows a user to select from the set of multimedia user assets, e.g., media files or other user-supplied content, provided to the system. The example user assets library 130 illustrated in FIG. 1 shows one possible organization of multimedia user assets into Images 131 (shown minimized to hide the list of uploaded images), 3D Models 132 containing files CherryTree.vrml 133 (shown selected) and SourGrapes.vrml 134, and Videos 135 containing files Intro.mp4 136 and flyover.wmv 137. User assets library 130 may also include Add button 138 allowing a user to upload additional assets. A multimedia user asset may be a file—e.g., a text file, MIDI file, an image, a 3D model, a video, an audio recording, an applet (e.g., a FLASH file or a JAR file), or a script file—or may be some collection of files. The term multimedia user asset may include multiple representations of the same underlying content, for example, the story of the cherry tree may be represented as text, an audio track of an actor reading the story, an audio track of concurrent sound effects, a video of the story, and an animated, 3D representation of the story. In another example, a multimedia user asset may be a brand logo in various forms, e.g., 2D, 3D, color, black and white, animated, static, or wireframe. Additional functions may be provided to the user as well, e.g., to change the display, search, remove, rename, organize, change permissions, or specify a start and/or end date beyond which the asset should not be used.

Properties page 140 allows the user to control the content and behavior of Applet 119. For example, properties page 140 may include the following GUI elements: applet type 141, Number 142, Can Hide 143, Dance 144, Move 145, and Preview pane 146. In this example, applet type 141 may be selected from a drop down menu and is currently set to “TextBugs.” The remaining elements on properties page 140 may differ, in some embodiments, based on the selected applet type 141. The TextBugs applet type displays animated lady bugs 148 on otherwise static text 147, as illustrated in Preview pane 146. The number of bugs may be specified by Number 142. If Can Hide 143 is enabled, one or more bugs 148 may be completely or partially obscured by text 147 or the underlying page. Dance 144 and Move 145 may further control the animation of bugs 148. Thus, by adding and configuring Applet 119 in this way, a viewer of the final “magic book” will see a playful animation of lady bugs interspersed with a display of Text 118. The user does not need to know how to illustrate and may easily change or remove this effect using GUI 100.

Finally, action buttons 151, 152 and 153 are GI elements that allow the user to indicate the status of the user's configuration activities to GUI 100. Save Draft 151 causes user interface to persist the current state of the user's edits to the application. Preview 152 causes user interface to launch a preview window, e.g., an internet browser window, displaying a generated preview version of the application. Finalize 153 causes user interface to allow the download or automated distribution of a final version of the application, e.g., an executable installation file to be downloaded and installed in a production environment.

The illustrated interface design, layout, component types, and information flow of GUI 100 are representative of some embodiments and should not be viewed as limiting. Other embodiments may make different design trade-offs with regard to complexity, workflow, aesthetics, etc. to better serve the target users. In some embodiments, GUI 100 includes one or more sequential wizards for creating the application. In some embodiments, GUI 100 provides a non-textual, block-based visual editor allowing a user to drag and drop actions, properties, media files, etc. onto and within an application pallet. In some embodiments, a user is provided a text-based interface for entering scripting commands or source code.

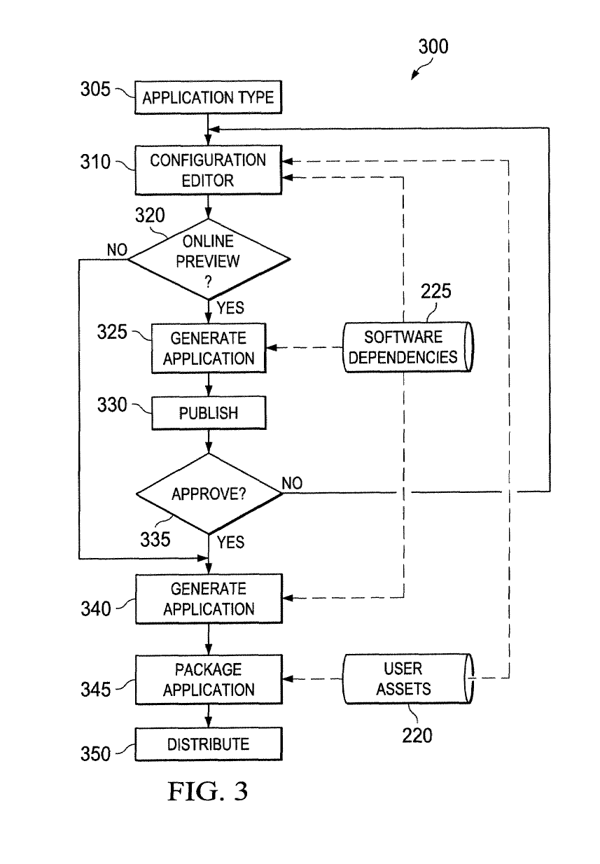

FIG. 2 illustrates a process and data flow for generating a multimedia application, according to an example embodiment of the present disclosure. A workflow illustrating the interplay between GUI 100 and process and dataflow 200 is discussed with reference to FIG. 3 later.

Returning to FIG. 2, process and data flow 200 may include a configuration editor 210 (e.g., in communication with GUI 100), user assets 220, software dependencies 225, an online preview execution branch 230, a final web execution branch 231, and a final executable execution branch 232. Each execution branch may include a series of process steps, which may be initiated by the user, e.g., via action buttons 151, 152, or 153 in GUI 100 and will be discussed in turn below. The process and data flow 200 begins when a user engages configuration editor 210 to develop a multimedia application referencing at least one multimedia user asset selected by the user from user assets 220, which were previously uploaded by the same or a different user. Once the user has completed at least a portion of the configuration process, the user may request an online preview of the application, e.g., by activating Preview button 152, shown in FIG. 1.

Software dependencies 225 may be a collection of software module relationships between software modules. Software modules may be classified as internal software modules or external software modules. Internal software modules may include modules developed by or on behalf of the organization offering the multimedia application development environment, and/or internal software modules are modules for which source code is available, e.g., in a collaborative development environment. In some embodiments, internal software modules may be stored in software dependencies 225 for subsequent access by other modules. External software modules may include modules provided by and/or acquired from third parties, e.g., SUN, MICROSOFT, or ADOBE, and may be developed and distributed external to the multimedia application development environment. External software modules may be stored in software dependencies 225 or may be referenced with instructions to users to obtain and install one or more of those modules before executing the multimedia application. Dependency information may describe the relationships between, and/or compatibilities with, any two or more software modules.

Once an online preview has been requested (e.g., via Preview button 152), online preview execution branch 230 is activated. First, a compile process 240 will generate one or more components of a multimedia application capable of executing immediately, e.g., in a web browser. In some embodiments, compile process 240 may generate a web page referencing existing modules from the library of software dependencies 225 and providing configuration parameters to the same. In another embodiment, compile process 240 may generate object code, e.g., in the form of one or more JAVA class files for subsequent execution by a JAVA Virtual Machine (JVM) in a browser or as a standalone application. In yet another embodiment, compile process 240 may generate an SHOCKWAVE file or a SILVERLIGHT file. In one or more of these embodiments, software components from software dependencies 225 may be bodily incorporated into or externally referenced by the resulting application.

Next, a publish process 250 combines the application component(s) generated by compile process 240 with any externally referenced software modules from software dependencies 225 along with at least one referenced user asset 220. This combination of files is a multimedia application, or an online preview version of a multimedia application. Publish process 250 may generate one or more package files, each including a combination of application files, software dependencies, and/or user assets, or may arrange them in one or more file folders. Publish process 250 may then configure a web server (or other remotely accessible server) to serve up the combination to the user. In some embodiments, publish process 250 may configure the web server to require a password or some other secure authentication mechanism to restrict access to the user and anyone the user may then authorize. Alternatively, some embodiments may generate a difficult-to-guess uniform resource locator (URL) to provide security through obscurity. While compile 240 and publish 250 are illustrated and described as distinct and separate processes, the two processes may be combined, e.g., for efficiency reasons or to simplify the implementation, in some embodiments into a single, unified process.

Finally, an online preview application process 260 is performed when the user executes the multimedia application, for example, within a browser on the user's computer. In some embodiments, this preview is an online preview displayed entirely within a web browser. In these embodiments, the web browser may transparently download one or more files behind the scenes, e.g., SHOCKWAVE files or JAVA applets, for local execution within the web browser. The user may then interact with the multimedia application in order to verify that the actual behavior of the application conforms with the expected behavior and to perform any quality control processes desired. Once the user is satisfied with the resulting application, the user may then initiate a different execution branch, e.g., by activating Finalize button 153 (shown in FIG. 1). Otherwise, the user may return to configuration editor 210 for further modification of the application.

Once the user is satisfied with her configuration of the multimedia application, she may initiate a final web execution branch 231, e.g., via Finalize button 153. Final web execution branch 231 may produce a finalized application suitable for distribution to end-use terminals. A compile step 241 may perform the same general function as compile step 240, however compile step 241 may generate multiple different formats to support various end-use environments. For example, compile step 241 may generate a JAVA version of the application components in addition to a SHOCKWAVE version such that the final web-based application can execute on personal computer (PC) based systems as well as mobile or embedded systems. As another example, compile step 241 may build in browser and/or platform specific support into one or more web pages used to launch the multimedia application. This extended capability may require additional verification (e.g., regression testing) beyond what was performed during online preview application 260.

Next, a package step 251 combines the application component(s) generated by compile process 240 with any externally referenced software modules from software dependencies 225 along with at least one referenced user asset 220. This combination is packaged in a form that may be downloaded and installed on a web server operated by or on behalf of the user. This final form may be identified as a unique application for tracking purposes. In some embodiments, the combination may be encapsulated in a self-extracting archive file and may include a setup application for configuring the target web server. In other embodiments, the combination may be a standard archive file (e.g., TAR, ZIP, or JAR). In still other embodiments, the combination may be organized in a folder structure and package step 251 provides an installer application to retrieve each file of the combination individually for storage on the target web server. As with compile step 241, package step 251 may generate multiple installers or a single, cross-platform installer, to allow the user to install the final web application on a heterogeneous set of web servers. If a setup program is included, that program may also install and/or update any required third-party applications. These required third-party applications are identified in software dependencies 225.

Lastly, a final web application step 261 includes a cataloging of the component parts of this multimedia application and may include distribution of this multimedia application to end-use terminals or one or more intermediate storage locations, e.g., an optical disk to be shipped out or an intermediate web server for facilitating distribution to other web servers.

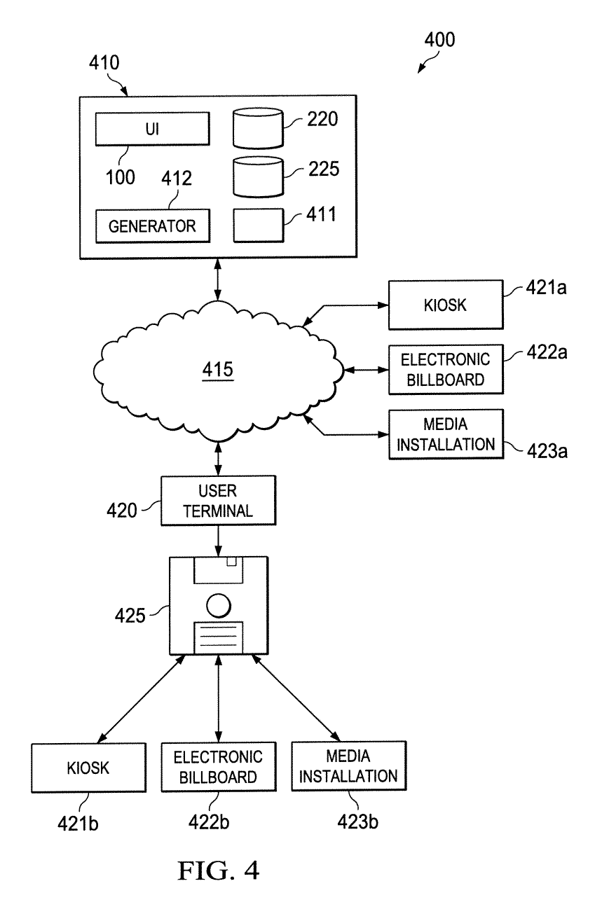

Once the user is satisfied with her configuration of the multimedia application, she may initiate a final executable branch 231, e.g., via Finalize button 153. Final executable branch 231 may produce a finalized application suitable for distribution to end-use terminals (e.g., kiosk 421, electronic billboard 422, or media installation 423 shown in FIG. 4). Final executable branch 232 may be similar to final web execution branch 231, but again, with a different end result, e.g., a stand-alone executable that may be run on a detached end-use terminal or may be run on a networked end-use terminal for fetching, on-demand, one or more user assets. A compile step 242 may generate JAVA or SHOCKWAVE applications or may generate a system-specific executable for optimal performance, e.g., using WINDOWS-compatible dynamically linked libraries (DLL). In some embodiments, compile step 242 may generate source code and use, e.g., a C++ compiler and linker to produce a WINDOWS executable. As with compile step 241, cross-platform support may be desired. In that case, compile step 242 may produce executables and/or DLLs for more than one platform, e.g., OSX, WINDOWS, and/or LINUX.

Next, a package step 252 combines the application component(s) generated by compile process 242 (e.g., DLLs, executables, resource files) into one or more installation files. As with package step 251, the installation file may be an archive, a self-extracting archive, or a self-extracting archive with a included setup program to configure the target system. This final form may be identified as a unique application for tracking purposes. If a setup program is included, that program may also install and/or update any required third-party applications. These required third-party applications are identified in software dependencies 225.

Lastly, a final executable application step 262 includes a cataloging of the component parts of this multimedia application and may include distribution of this multimedia application to end-use terminals or one or more intermediate storage locations, e.g., an optical disk to be shipped out or a web server for facilitating distribution to end-user terminals.

FIG. 3 illustrates an example workflow 300 performed according to an example embodiment of the present disclosure. Workflow 300 illustrates an example interplay of GUI 100 and process and data flow 200 and provides a high level view of the steps a user may take or initiate in the course of generating a multimedia application. In the initial step of workflow 300, the user selects an application type 305, e.g., via GUI 100. Next, the user configures application parameters in a configuration editor 310, e.g., via GUI 100, and selects at least one user supplied media asset from user assets 220 for inclusion in the multimedia application. Configuration editor 310 verifies that the configuration satisfies any relevant software dependencies stored in software dependencies 225. Once the application has been configured, the user indicates, e.g., via GUI 100, whether or not a online preview 320 is desired. If so, an application is generated at a generate application step 325 and published at a publish step 330, e.g., on a web server for execution in a web browser. The user has the opportunity to verify the application in her web browser. The user then indicates, e.g., via GUI 100, whether or not she approves of the application. If not, the user returns to configuration editor 310 to modify one or more parameters.

If the user approves of the application, or if no online preview was desired, the final application is generated at a generate application step 340 and packaged at a package application step 345 with any referenced user assets from user assets 220. The resulting package, e.g., a software installer, is distributed at distribute step 350 to one or more end-use terminals (e.g., kiosk 421a or 421b, electronic billboard 422a or 422b, or media installation 423a or 423b shown in FIG. 4).

FIG. 4 illustrates example system 400 for generating a multimedia application, according to an example embodiment of the present disclosure. Computer 410, e.g., a server, may communicate via network 415 with user terminal 420, kiosk 421a, electronic billboard 422a, and/or media installation 423a. User terminal 420 may communicate, via removable media 425, with kiosk 421b, electronic billboard 422b, and/or media installation 423b.

A computer 410 may be any type of computer, but may be a server configured with sufficient computing, data storage, and networking resources to reliably support multiple simultaneous users. Computer 410 may be a single computer, multiple computers, a virtualized computer, and/or a service provided in a cloud computing environment. Computer 410 includes GUI 100, a central processing unit 411, a multimedia application generator 412, and a memory storing user assets 220 and software dependencies 225. Central processing unit 411 may be, for example, an X86-compatible processor. Multimedia application generator 412 may be one or more software modules capable of interpreting user-supplied application configuration data into appropriate HTML script, generated source code, and/or object code to produce a final application, Multimedia application generator 412 may include scripting modules and/or compiled modules. Multimedia application generator 412 may also be capable of generating and/or compiling cross-platform object code, generating installation package files, and performing other tasks discussed in relation to compile 240, 241, and 242; publish 250; and/or package 251 and 252.

Computer 410's memory, including that which stores user assets 220 and software dependencies 225, may be any form of tangible computer readable media including, for example, any type of random access memory (RAM), non-volatile storage such as flash memory, magnetic memory, or optical memory, or any combination of the same, A network 415 provides data connectivity between various elements in FIG. 4. Network 415 may be, for example, a LAN, WAN, and/or the Internet. Elements, e.g., computer 410, may be directly connected or may connect via a firewall, virtual private network, or other technologies.

A user terminal 420 enables a user to remotely access GUI 100 on computer 410 via, e.g., a web browser. User terminal 420 may be, for example, a personal computer, a thin-client terminal, or a smart phone, User terminal 420 may include a web browser and a variety of common plug-ins including, for example, SHOCKWAVE, FLASH, SILVERLIGHT, and/or JAVA VM, enabling a rich user experience for configuring a multimedia application. User terminal 420 may also include a web server for serving final web application 261 and/or support installation and execution of final executable application 262 (both illustrated in FIG. 2). User terminal 420 may be a single computer or may be many computers, any one of which may have more than one user. User terminal 420 may provide access to removable media 425 for distributing a multimedia application to one or more devices where network connectivity is not available or the use of that network connectivity is disfavored. Removable media 425 may be any form of nonvolatile, tangible, computer-readable memory including, for example, battery backed-up RAM, flash, magnetic disk, optical disk, punched cards, and magnetic or optical tape.

A media installation 423 (e.g., media installation 423a or 423b) may be an arrangement of processing and input/output components allowing one or more participants to view and/or interact with a multimedia application. For example, media installation 423 may allow participants to play a game of virtual football (i.e., soccer) where users see a mirror image of themselves on a display with a virtual football superimposed on the screen. When a participants kicks and makes virtual contact with the virtual football, the virtual football reacts accordingly. Media installation 423 may include a computer, for example, a personal computer, a video game console, or an embedded computer; one or more video cameras and/or other sensors for observing participants; a display, e.g., one or more flat panel displays and/or video projectors; and one or more amplified speakers. Media installation 423 may also include a web browser, one or more third-party applications, e.g., FLASH, JAVA, DIRECTX, and video codecs, as well as sufficient memory and processing power to execute the multimedia application. Media installation 423a may also include network connectivity to computer 410 for direct download of a multimedia application, performed manually or automatically, whereas media installation 423b may receive a copy of a multimedia application via removable media 425.

A kiosk 421 (e.g., kiosk 421a or 421b) may be a freestanding or wall-mounted computer terminal enabling a participant to interact with a multimedia application. For example, kiosk 421 may allow participants to interact, e.g., via a touch screen, with a digital map of a historical site to learn more about events occurring at specific map locations. Kiosk 421 may include a computer, for example, a personal computer, a video game console, or an embedded computer; a display with a touch screen and/or other sensors for observing participants; a microphone; and one or more amplified speakers. Kiosk 421 may also include a web browser, one or more third-party applications, e.g., FLASH, JAVA, DIRECTX, and video codecs, as well as sufficient memory and processing power to execute the multimedia application. Kiosk 421a may also include network connectivity to computer 410 for direct download of a multimedia application, performed manually or automatically, whereas kiosk 421b may receive a copy of a multimedia application via removable media 425.

An electronic billboard 422 (e.g., electronic billboard 422a or 422b) may be a freestanding or wall-mounted flat display incorporating a hidden computer terminal enabling members of the public to view a multimedia application. For example electronic billboard 422 may display a dynamic video advertisement or presentation, for example, on a large projection screen or wall-mounted flat panel display. The multimedia application may be interactive and may respond to individual input, e.g., via a text messages from cell phones, or collective input, e.g., via motion or proximity sensors. Electronic billboard 422 may include a computer, for example, a personal computer, a video game console, or an embedded computer; a display; one or more video cameras and/or other sensors for observing participants; one or more microphones; and one or more amplified speakers. Electronic billboard 422 may also include a web browser, one or more third-party applications, e.g., FLASH, JAVA, DIRECTX, and video codecs, as well as sufficient memory and processing power to execute the multimedia application. Electronic billboard 422a may also include network connectivity to computer 410 for direct download of a multimedia application, performed manually or automatically, whereas electronic billboard 422b may receive a copy of a multimedia application via removable media 425.

While three types of end-user terminals have been described herein as examples—i.e., kiosk 421a and 421b, electronic billboard 422a and 422b, and media installation 422a and 422b—other types of end-user terminals may be compatible with the system and methods of the present disclosure including hybrids of the three example types.

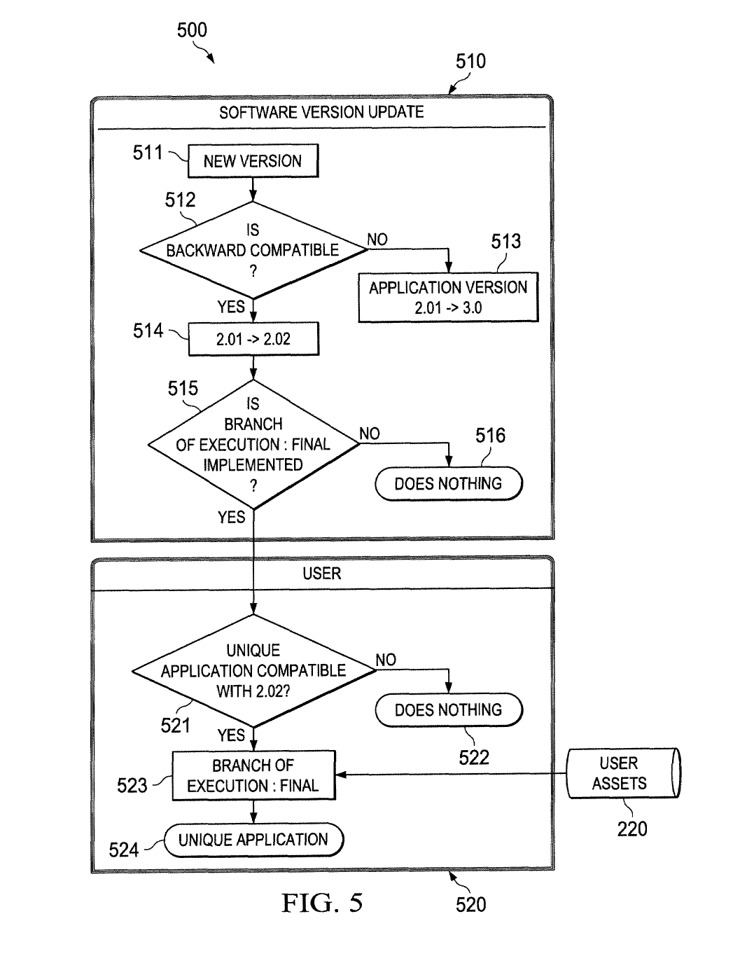

FIG. 5 illustrates an example workflow process 500 triggered when an updated version of a software module is created, according to an example embodiment of the present disclosure. This workflow is designed to assist users in updating installed multimedia applications to take advantage of software enhancements and/or fixes. Workflow 500 is illustrated in two parts, software version check 510 and user input 520. A software version update process 510 may be triggered when a new version 511 of a 5 software module is added software dependencies 225 (illustrated in FIG. 2). In some embodiments, a software developer may determine whether or not the version is backward compatible at step 512. In some embodiments, an automated process may make or verify this determination by comparing available configuration parameters and cross-dependencies. If the new version is not backward compatible, then the major version number is incremented and the workflow process ends at step 513 because a user must reconfigure the multimedia application before proceeding. If the new version is backward compatible, then the minor version number is incremented at step 514 and the process continues.

Next, the system automatically identifies multimedia applications where the final executable branch (or the final web application branch) has been implemented at step 515, thus creating a unique application. If not, then no action is taken 516 as there is no application to update. Specifically, when the user finalizes the application (e.g., via GUI 100), the current version of the modified software module will be incorporated.

For each final multimedia application identified, user input workflow 520 may be performed by notifying the user responsible for the unique application. The user may be notified via, for example, email or a notice when the user logs into GUI 100. Once the user logs into the system, e.g., into GUI 100, the system may automatically notify the user, at step 521, whether or not the new version is compatible with the unique application. In certain embodiments, the modified software module may be associated with a major and minor version number. If the major version number has been incremented, then the modified software module is not backward compatible whereas if only the minor version number has been incremented, it is backward compatible. Thus the system may automatically determine the backward compatibility based at least in part on the version number.

In some embodiments, the system may perform step 521 using automated regression testing or by validating the existing configuration parameters against known acceptable values and/or combinations. If the unique application is not compatible, then no action is taken at step 522. Otherwise, the final executable branch of execution (and/or the final web branch of execution) is performed wherein the new software module is incorporated with user assets 220 into a new unique application 524. This new unique application may then be distributed by the user or in an automatic process. Because steps 521, 522, 523, and 524 may be automatically performed, the user input workflow 520 may inform the user of the results, e.g., that a new unique application has been generated at step 524, or that a new version exists but is not compatible at step 522.

Alternatively, the system may involve the user in step 521. For example, GUI 100 may launch an online preview version, which incorporates the updated software module. The user may then view and/or interact with the online preview version to verify proper appearance and/or behavior. If the user determines that the unique application is not compatible, then no action is taken at step 522. Otherwise, the final executable branch of execution (and/or the final web branch of execution) is performed wherein the new software module is incorporated with user assets 220 into a new unique application 524. This new unique application may then be distributed by the user or in an automatic process.

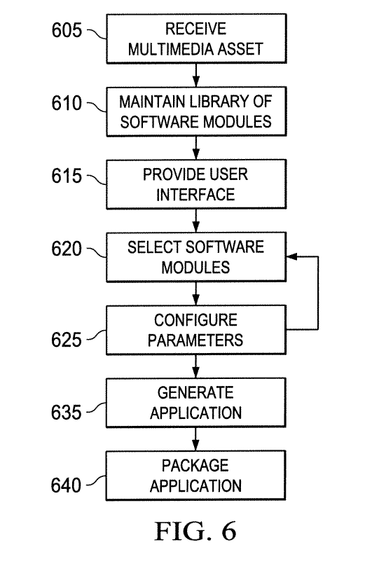

FIG. 6 illustrates an example method 600 performed by system 400 for generating a multimedia application, in accordance with certain embodiments of the present disclosure. At step 605, at least one multimedia asset may be received by the system. This asset may be, for example, an image, a sound file, a video file, an applet, or a 3D model. At step 610, a library may be maintained of software modules including versioning and dependency information. At step 615, a user interface, e.g., GUI 100, may be provided for a user to interact with system 400. At step 620, a user may select one or more software modules for inclusion in the multimedia application. This step may involve, for example, selecting an application type or selecting one or more individual modules to add to a selected application type. At step 625, a user may configure one or more parameters for the selected software module. Steps 620 and 625 may be repeated where multiple software modules are desired. At step 635, the multimedia application may be generated. If the application is in final form, the application may be designated as a unique application and tracked by system 400. At step 640, the application may be packaged for distribution to one or more end-user terminals.

Although the disclosed embodiments are described in detail in the present disclosure, it should be understood that various changes, substitutions and alterations can be made to the embodiments without departing from their spirit and scope.

What is claimed is:

1. A computer implemented method for developing a multimedia application, comprising:
receiving a multimedia asset over a data network from a user;
maintaining a library of a plurality of internal software modules;
providing a user interface configured to allow a user to:
select one or more of the plurality of internal software modules, and
configure a plurality of parameters for controlling a selected internal software module, wherein at least one of the configured parameters references the multimedia asset received over the data network from the user;
automatically generating a first multimedia application, which includes:
the user-selected internal software module,
an identifier for determining the version of the user-selected internal software module, and
the plurality of user-configured parameters including the reference to the multimedia asset received over the data network from the user;
receiving an updated user-selected internal software module; and
automatically generating a second multimedia application, which includes:
the updated user-selected internal software module,
an identifier for determining the version of the updated user-selected internal software module, and
the plurality of user-configured parameters including the reference to the multimedia asset received over the data network from the user.

2. The computer implemented method of claim 1 further comprising automatically generating an installation package including:
the first multimedia application;
the referenced at least one multimedia asset received over the data network from the user.

3. The computer implemented method of claim 1 further comprising automatically generating a website that provides web-based access and execution of the first multimedia application, which incorporates the referenced multimedia asset received over the data network from the user.

4. The computer implemented method of claim 1 further comprising:
automatically notifying the user that the updated user-selected internal software module is backward compatible with the first generated application;
receiving an instruction from the user to initiate the step of automatically generating the second multimedia application.

5. The computer implemented method of claim 1 further comprising:
automatically notifying the user of a modification of the user-selected internal software module included in the first multimedia application; and
requiring the user to configure at least one of the plurality of parameters for controlling the updated user-selected internal software module.

6. The computer implemented method of claim 1 wherein the user interface includes one or more of the following user interface elements:
a wizard;
a graph of interconnected blocks representing selectable or configurable assets; and
a script editor.

7. The computer implemented method of claim 2 further comprising automatically distributing the installation package to a plurality of end-user systems.

8. The computer implemented method of claim 1 further comprising activating the generated multimedia application upon the satisfaction of a condition by at least one of:
automatic validation of a manually entered license key;
automatic determination that the current time and date falls within a predetermined range;
manual activation by the user; and
automatic validation of a physical token.

9. Software embodied in tangible computer-readable media and, when executed by a processor, operable to:
receive a multimedia asset over a data network from a user;
maintain a library of a plurality of internal software modules;
provide a user interface configured to allow a user to:
select one or more of the plurality of internal software modules, and
configure a plurality of parameters for controlling a selected internal software module, wherein at least one of the configured parameters references the multimedia asset received over the data network from the user;
automatically generate a first multimedia application, which includes:
the user-selected internal software module,
an identifier for determining the version of the user-selected internal software module, and
the plurality of user-configured parameters including the reference to the multimedia asset received over the data network from the user;
receive an updated user-selected internal software module; and
automatically generate a second multimedia application, which includes:
the updated user-selected internal software module,
an identifier for determining the version of the updated user-selected internal software module, and
the plurality of user-configured parameters including the reference to the multimedia asset received over the data network from the user.

10. The software of claim 9 further operable to automatically generate an installation package including:
the first multimedia application;
the referenced at least one multimedia asset received over the data network from the user.

11. The software of claim 9 further operable to automatically generate a website that provides web-based access and execution of the first multimedia application, which incorporates the referenced multimedia asset received over the data network from the user.

12. The software of claim 9 further operable to:
automatically notify the user of a modification of the user-selected internal software module included in the first multimedia application; and
receive an instruction from the user to initiate the step of automatically generating the second multimedia application.

13. The software of claim 9 further operable to:
automatically notify the user of a modification of the user-selected internal software module included in the first multimedia application; and
require the user to configure at least one of the plurality of parameters for controlling the updated user-selected internal software module.

14. The software of claim 9 wherein the user interface includes one or more of the following user interface elements:
a wizard;
a graph of interconnected blocks representing selectable or configurable assets; and
a script editor.

15. The software of claim 10 further operable to automatically distribute the installation package to a plurality of end-user systems.

16. A computing system comprising:
a processor;
a memory coupled to the processor; and
a multimedia application generator enabled to:
receive a multimedia asset over a data network from a user;
maintain a library of a plurality of internal software modules;
provide a user interface configured to allow a user to:
select one or more of the plurality of internal software modules, and
configure a plurality of parameters for controlling a selected internal software module, wherein at least one of the configured parameters references the multimedia asset received over the data network from the user;
automatically generate a first multimedia application, which includes:
the user-selected internal software module,
an identifier for determining the version of the user-selected internal software module, and
the plurality of user-configured parameters including the reference to the multimedia asset received over the data network from the user;
receive an updated user-selected internal software module; and
automatically generate a second multimedia application, which includes:
the updated user-selected internal software module,
an identifier for determining the version of the updated user-selected internal software module, and
the plurality of user-configured parameters including the reference to the multimedia asset received over the data network from the user.

17. The computing system of claim 16, wherein the multimedia application generator is further enabled to automatically generate an installation package including:
the first multimedia application;
the referenced at least one multimedia asset received over the data network from the user.

18. The computing system of claim 16, wherein the multimedia application generator is further enabled to automatically generate a website that provides web-based access and execution of the first multimedia application, which incorporates the referenced multimedia asset received over the data network from the user.

19. The computing system of claim 16, wherein the multimedia application generator is further enabled to:
automatically notify the user of a modification of the user-selected internal software module included in the first multimedia application; and
receive an instruction from the user to initiate the step of automatically generating the second multimedia application.

20. The computing system of claim 16, wherein the multimedia application generator is further enabled to:
automatically notify the user of a modification of the user-selected internal software module included in the first multimedia application; and
require the user to configure at least one of the plurality of parameters for controlling the updated user-selected internal software module.
